(19) United States
(12) Patent Application Publication
(10) Pub. No.: US 2014/0141754 A1
(43) Pub. Date: May 22, 2014

(54) MOBILE PHONE WITH CALL PROMPTING FUNCTION AND METHOD THEREOF

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: XIAN QIAN, Shenzhen (CN); JING-TING WANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/717,731

(22) Filed: Dec. 18, 2012

(30) Foreign Application Priority Data
Nov. 19, 2012 (CN) 201210468253.2

(51) Int. Cl. H04M 3/48; H04W 4/16

(52) U.S. Cl. CPC H04M 3/48; H04W 4/16
USPC 455/414.1

(57) ABSTRACT

The disclosure provides a call prompting function and a call prompting method adapted for a mobile phone. When the mobile phone is already busy and receives another call, the mobile phone acquires a phone number of the unanswered and blocked mobile phone. When the phone call ends, the mobile phone sends a short message to the unanswered and blocked mobile phone, informing the user of the unanswered and blocked mobile phone that the first mobile phone is now available for calls, avoiding further wasted call attempts.

### BACKGROUND

1. Technical Field

The disclosure relates to mobile phones and, more particularly, to a mobile phone with call prompting function and a call prompting method adapted for the mobile phone.

2. Description of Related Art

When a user of a mobile phone calls another mobile phone and gets a busy signal, the user may hang up and then call again and again. The user may try to dial many times and thus waste a lot of time while the mobile phone being called remains busy, it is very inconvenient for the user of the second mobile phone.

Therefore, what is needed is a mobile phone with call prompting function to overcome the described shortcoming.

### BRIEF DESCRIPTION OF THE DRAWINGS

FIG. 1 is a block diagram of a mobile phone with call prompting function in accordance with an exemplary embodiment.

FIG. 2 is a block diagram of a call prompting system of the mobile phone of FIG. 1.

FIG. 3 is a flowchart of a call prompting method adapted for the mobile phone of FIG. 1.

### DETAILED DESCRIPTION

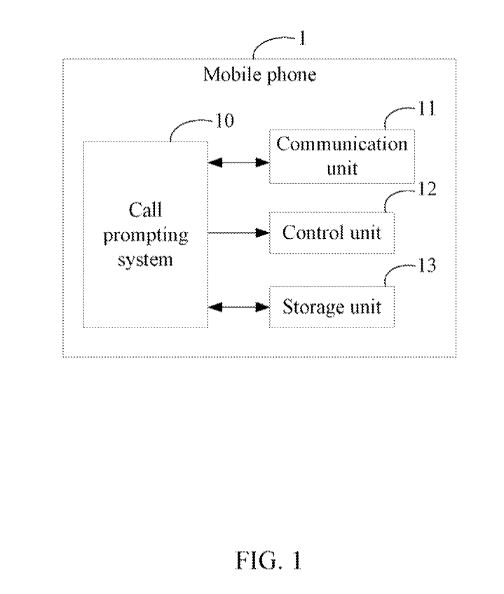

FIG. 1 is a block diagram of a mobile phone with call prompting function in accordance with an exemplary embodiment. The mobile phone 1 includes a call prompting system 10, a communication unit 11, a control unit 12, and a storage unit 13. The communication unit 11 transmits and receives wireless signals. The storage unit 13 stores data. The control unit 12 runs the call prompting system 10 and performs each function of each module of the call prompting system 10.

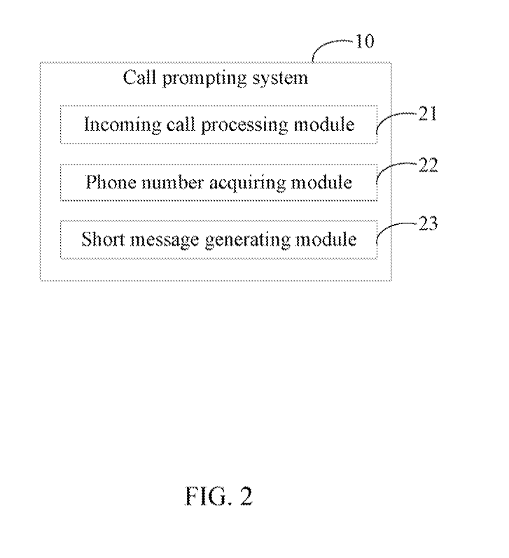

As shown in FIG. 2, the user information protecting system 10 further includes an incoming call processing module 21, a phone number acquiring module 22, and a short message generating module 23.

When the mobile phone 1 is already communicating with a caller and the communication unit 11 receives a new incoming call signal, the incoming call processing module 21 is activated by the new incoming call and the phone number acquiring module 22 acquires a phone number of the new incoming call and stores the phone number (hereinafter “blocked number”) in the storage unit 13.

When the original communication ends, for example, the mobile phone 1 receives a signal from a hang-up key (not shown), the incoming call processing module 21 generates a trigger signal. The mobile phone 1 is then in an idle state and is open to calls made by other mobile phones.

The short message generating module 23 generates a short text message in response to the trigger signal and controls the communication unit 11 to send the short message to the blocked number. The short message is formulated to inform the user of the mobile phone to which the blocked number belongs that the mobile phone 1 is idle. For example, the short message may include a content “Hello, sorry for being busy, please call now.”

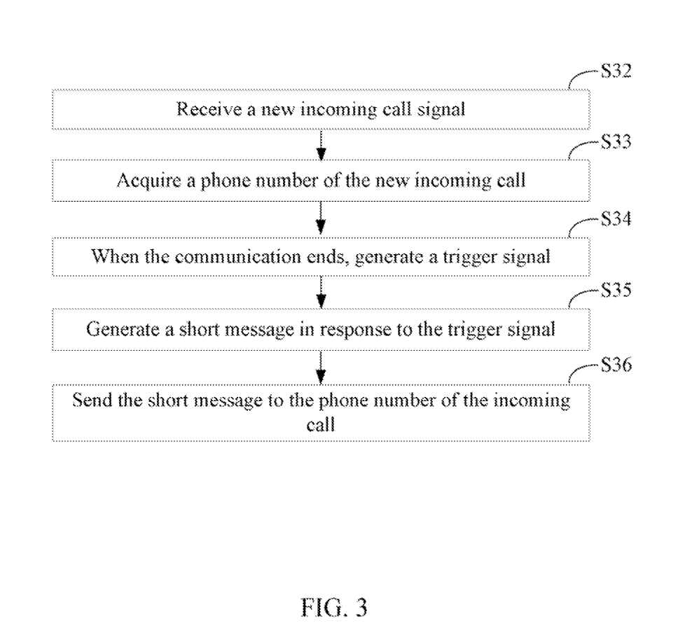

FIG. 3 shows a flowchart of an embodiment of a call prompting method adapted for the mobile phone of FIG. 1. In step S32, when the mobile phone 1 is already in communication with a caller, the communication unit 11 receives a new incoming call signal. In step S33, the incoming call processing module 21 is activated by the new incoming call and the phone number acquiring module 22 acquires a phone number of the new incoming call and stores the phone number (“blocked number”) in the storage unit 13.

In step S34, when the original communication ends, the incoming call processing module 21 generates a trigger signal. In step S35, the short message generating module 23 generates a short text message in response to the trigger signal. In step S36, the communication unit 11 sends the short message to the blocked number.

By these means, a waste of time and effort by the new caller is avoided, as the mobile phone 1 will send a short message to advise the user of the blocked number that the mobile phone 1 is now idle and can take calls again.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A mobile phone comprising:
a storage unit;
a communication unit for transmitting and receiving wireless signals; and
a control unit;
one or more programs stored in the storage unit, executable by the control unit, the one or more programs comprising:
a phone number acquiring module operable to acquire a phone number of a new incoming call when the mobile phone is communicating with a caller and the communication unit receives the new incoming call signal;
an incoming call processing module operable to generate a trigger signal when the communication ends; and
a short message generating module operable to generate a short message in response to the trigger signal from the incoming call processing module and control the communication unit to send the short message to the phone number of the new incoming call.

2. The mobile phone as recited in claim 1, wherein the short message is defined to prompt the caller of the new incoming call that the mobile phone is idle.

3. A call prompting method adapted for a mobile phone, the method comprising:
when the mobile phone is communicating with a caller and receiving a new incoming call signal, acquiring a phone number of the new incoming call;
when the communication ends, generating a trigger signal; and
generating a short message for call prompting in response to the trigger signal and sending the short message to the phone number of the new incoming call.

4. The call prompting method as recited in claim 3, wherein the short message is defined to prompt the caller of the new incoming call that the mobile phone is idle.
